(19) United States
(12) Patent Application Publication
(10) Pub. No.: US 2017/0270448 A1
(43) Pub. Date: Sep. 21, 2017

(54) VEHICLE SCHEDULING DEVICE AND METHOD FOR TRANSPORTATION SYSTEMS

(71) Applicant: Jusda International Logistics (TAIWAN) CO.,LTD, Taoyuan (TW)

(72) Inventors: CHIA-LIN KAO, New Taipei (TW); FENG-TIEN YU, Taipei City (TW)

(21) Appl. No.: 15/073,825

(22) Filed: Mar. 18, 2016

(51) Int. Cl. G06Q 10/06

(52) U.S. Cl. CPC G06Q 10/06314

(57) ABSTRACT

A vehicle scheduling device includes a processor configured to perform at least one objective function. An input interface communicatively is coupled to the processor and configured to accept input of a scheduling data, and the scheduling data includes at least one door environment parameter, an operational parameter, and dynamic information. A computer readable medium coupled to the processor and configured to receive the scheduling data, the computer readable medium further includes instructions stored therein, upon when executed by the processor, causes the processor to perform operations to generate an optimal scheduling plan. A display device is coupled to the processor and configured to output a visual representation of the optimal scheduling plan.

### FIELD

The subject matter herein generally relates to a vehicle scheduling device and method for transportation systems.

### BACKGROUND

Scheduling problems in general deal with the allocation of resources over time to perform a set of tasks that are a part of some process. In the special case of vehicle scheduling, the process of transshipment can be subdivided into the tasks of unloading inbound vehicles and loading outbound vehicles, which are typically separated by a lag time for handling materials inside the terminal, i.e. scanning, sorting, and moving shipments across the dock. These two tasks are processed by the resources ‘dock doors’, which can process one vehicle at a time and it is assumed that they are sufficiently equipped with loading equipment (e.g., hand stackers or fork lifts) and laborers. Distribution operations are complex and challenging. Assigning inbound vehicles and outbound vehicles to dock doors in transportation or distribution system is a relatively new topic which becomes popular in the last few decades. The present disclosure provides a device and a method for providing the inbound-vehicle and outbound-vehicle dock door assignment strategies.

### BRIEF DESCRIPTION OF THE DRAWINGS

Implementations of the present technology will now be described, by way of example only, with reference to the attached figures.

FIG. 1 illustrates a system diagram of a transportation system in accordance with aspects of the disclosure.

FIG. 2 illustrates a system diagram of a transportation system with a vehicle scheduling device in a distribution center in accordance with aspects of the disclosure.

FIG. 3 illustrates a block diagram of a vehicle scheduling device in accordance with an implementation.

FIG. 4 illustrates a block diagram of a transportation system in accordance with an implementation.

FIG. 5 illustrates a system diagram of a transportation system in accordance with an implementation.

FIG. 6A illustrates a flowchart illustrating a vehicle scheduling method.

FIG. 6B illustrates a diagram of Genetic algorithm (GA) in accordance with an implementation.

FIG. 6C illustrates another diagram of Genetic algorithm (GA) in accordance with an implementation.

FIG. 6D illustrates another flowchart illustrating a vehicle scheduling method.

FIG. 7 illustrates a system diagram of a distribution system in accordance with an implementation.

FIG. 8 is an application interface of a vehicle scheduling device.

FIG. 9 is another application interface of a vehicle scheduling device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “comprising” means “including, but not necessarily limited to”; it specifically indicates open-ended inclusion or membership in a so-described combination, group, series and the like.

The present disclosure proposes transportation system to manage the vehicle and door assignments in a distribution center via a vehicle scheduling device and method thereof.

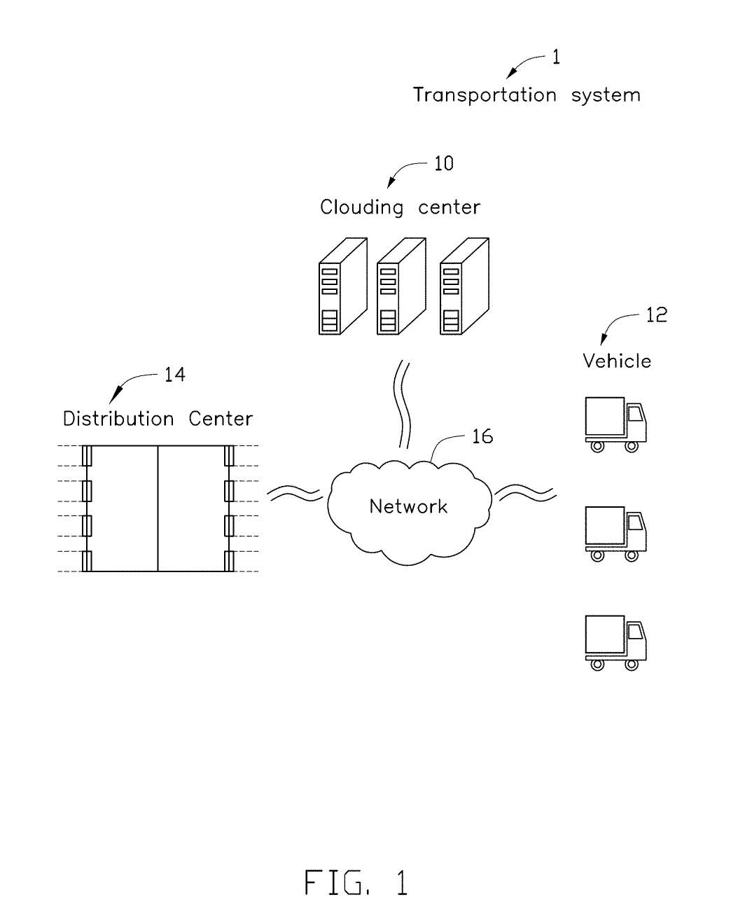

FIG. 1 illustrates a transportation system 1 comprises a distribution center 14 and vehicles 12. The distribution center 14 receives vehicles related information, and accordingly formulates inbound-vehicle and outbound-vehicle door assignment strategies for the distribution center 14. Recently, cloud computing technologies have been introduced in different industries. In the instant embodiment, a cloud center 10 is provided in the transportation system 1 as a new addition. The distribution center 14, the vehicles 12 and the cloud center 10 are communicatively coupled through a network 16. The data provided from the distribution center 14 or the vehicles 12 may be computed by the cloud center 10.

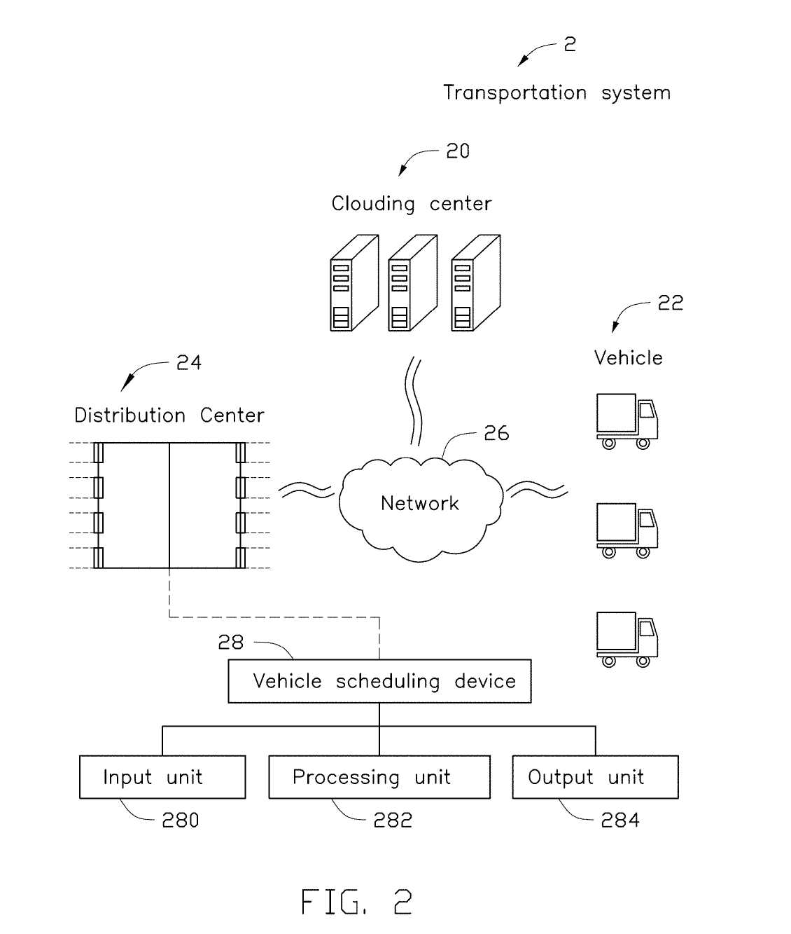

FIG. 2 illustrates a transportation system 2, wherein a vehicle scheduling device 28 is provided in a distribution center 24 as one embodiment (The vehicle scheduling device can be also provided in a cloud center as another embodiment). The vehicle scheduling device 28 is generally configured to collect transportation information, such as vehicle information, logistic information, or distribution information. In at least one embodiment, a vehicle scheduling device 28 is provided in the transportation system 2 via a network 26, wherein the transportation system 2 comprises a cloud center 20, a vehicle 22 and a distribution center 24. The vehicle scheduling device 28 can be generally integrated in the distribution center 24 (in other embodiments, the vehicle scheduling device 28 can also be in the cloud center 20 or the vehicle 22). The vehicle scheduling device 28 is configured to receive scheduling data from a user of the vehicle scheduling device 28. The vehicle scheduling device 28 comprises an input unit 280 including an input device (e.g., cellular telephone, personal digital assistant (PDA), laptop, radio, broadcasting, walkie-talkie etc.) for users to input a scheduling plan, a processing unit 282 having hardware and associated software (e.g., cellular telephone, personal digital assistant (PDA), laptop, radio, broadcasting, walkie-talkie etc.) for processing the scheduling plan based on the input data from the input device, and a output unit 284 (e.g., monitor, cellular telephone, personal digital assistant (PDA), laptop, radio, broadcasting, walkie-talkie etc.) for presenting a visual representation of the scheduling plan. The scheduling plan is used by vehicle scheduling authorities to control vehicles 22 in the transportation system 2. The scheduling plan can help vehicle drivers understand what time to go, which dock/door to go, what shipment should be loaded, or what sequence for unloading. In other embodiments, the vehicle scheduling device 28 may be integrated in the cloud center 20 or the vehicle 22. The vehicle scheduling device 28 may receive information from the cloud center 20 or the vehicle 22.

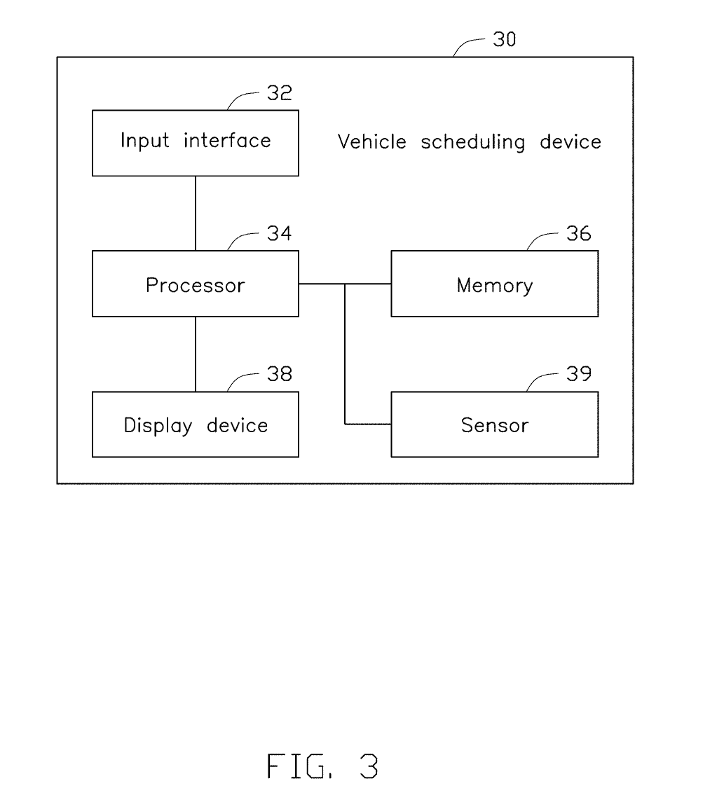

FIG. 3 illustrates a schematic block diagram comprising components for an exemplary vehicle scheduling device. The exemplary vehicle scheduling device 30 comprises an input interface 32, a memory 36, a processor 34 and a display device 38. The input interface 32 is coupled to the memory 36, the processor 34, or the display device 38, and is operable to allow input of scheduling data. The memory is configured to receive and store the scheduling data. The processor 34 is configured to execute programs, applications, or software associated with the scheduling data provided by the memory 36. The display device is configured to present visual representations of the processed results (e.g., a scheduling plan) of the processor 34. The processed results may comprise (1) the objective results, (2) the door allocation and the time operation of each truck and (3) the schedule of vehicles and doors of the whole system.

The scheduling data may comprise door environment parameters, operational parameters, and dynamic information. The dynamic information further comprises information regarding the departure and arrival time of the vehicle, shipment capacity of the vehicle, the type of shipment, the number of doors or the types of products in the shipment.

In some embodiments, the user can input different parameters as a default setting of the vehicle scheduling device 30 through the input interface 32 to choose which parameters to be stored in the memory 36 and to be executed by the processor 34.

The user can also input dynamic information, such as the departure time of the vehicle, arrival time of the vehicle, shipment capacity of the vehicle, the types of shipment, the number of doors or the types of products in the shipment.

In some embodiments, the default settings, such as the door environment parameters and the operational parameters, are pre-stored in the memory 36.

In some embodiments, the door environment parameters comprise parameters associated with the scheduling plan, e.g., the jobs executed during cross docking in the distribution center related to the inbound (unloading) and outbound (loading) operations. For example, the door environment parameters may comprise parameters regarding the service modes and the number of dock doors.

The service modes generally refer to the operation modes of the dock door(s). The service modes may include (i) an exclusive mode, in which a particular dock door is for designated exclusively for inbound or outbound operation (i.e., an exclusive mode), (ii) a mixed mode, in which the dock door is not exclusively designated for the purpose of an inbound or outbound door only, (iii) an exclusive-mixed mode, in which the dock doors are designated for parallel usage in both the exclusive and the mixed modes, and (iv) a given mode, in which the door assignment of each vehicle is given by a certain destination. The number of dock doors can be assigned and input by the user.

The operational parameter may comprise pre-emption existence, arrival time, processing time, due dates, intermediate storage parameter, assignment restriction, transshipment time, outbound organization, and interchangeable shipment/product. The user can choose different modes through the input interface.

The pre-emption existence may comprise two options respectively indicating whether a pre-emption/operation interruption is allowed or not.

The arrival time may comprise two options, which include that all the vehicle arrival times are assumed to be zero and each vehicles' arrival times are different.

The processing time may comprise three options, which include varying processing times for each vehicle, all vehicles having the same processing time, and processing times depending on specific range.

The due dates may comprise two options, including no specific due dates, (due dates are defined as soft constraints), and due dates are defined.

The intermediate storage parameter may comprise three options, which include unlimited intermediate storage between inbound and outbound dock doors, the storage is limited by a given capacity, and there is no intermediate storage allowed.

The assignment restriction may comprise two options, including no exclusive door for specified vehicles, and which specific door is assigned to a specified vehicle, i.e. because of door size.

The transshipment time may comprise three options, which include transshipment times (times between the existence of shipments in the terminal and their availability at the outbound doors) are assumed to be a constant greater than zero, transshipment times are assumed to be zero, and transshipment times are specified according to the inbound and outbound door chosen.

The outbound organization may comprise two options, which include outbound vehicles leaving the terminal as soon as their specified capacities are met, and the departure times of vehicles timed from their arrival times to a fixed staying time.

The interchangeable shipment may comprise two options, which may include any shipment arriving at the terminal being dedicated to one specific outbound vehicle, and the number and types of shipments for each outbound vehicle are previously defined, and they are repackaged according to every vehicle requirement.

In at least one embodiment, the memory (which may include a volatile and/or non-volatile memory) is coupled to the input interface and is configured to receive and store the data, such as the scheduling plan from the input interface. Also for example, the memory can typically store programs, software applications, instructions or the like for the vehicle scheduling device to perform operations of the system accordance with any embodiments in the disclosure.

In at least one embodiment, the processor 34 coupled to the memory 36 is configured to receive data from the memory 36 and perform or control various objective functions of the vehicle scheduling device 30. For example, according to the embodiment of the present disclosure, the processor 34 may be configured to perform operations for processing various programs based on the door environment parameters, the operational parameters, and the dynamic information, wherein the programs may include mathematical model or algorithm capable of generating an optimal vehicle scheduling plan upon execution.

The objective functions may comprise “travel time minimum”, “makespan minimum”, “total late minimum,” and “late minimum of outbound vehicles.” The “travel time minimum” function is for minimizing the total travel time of forklifts on the dock. The “makespan minimum” function is for minimizing the total scheduling processing time from the first inbound vehicles to the last outbound vehicles. The “total late Minimum” function is for minimizing the total late time for the inbound and outbound vehicles. The “late minimum of outbound vehicles” function is for minimizing the total late time for outbound vehicles. The optimal scheduling plan can be generated based on the selected objective functions.

The display device 38 is coupled to the processor 34 and configured to receive output data from the processor 34. The display device 38 comprises a display screen to present a visual representation of the optimal scheduling plan based on the selected objective functions.

In at least one embodiment, the vehicle scheduling device 30 further comprises a sensor 39 which can detect the situation of the transportation environment and transmit dynamic information automatically to the processor 34 without manual interventions. For example, when the inbound vehicles starts travelling to the distribution center, the vehicle scheduling device 30 would automatically detect the time and the position of the inbound vehicles through the sensor 39 so that the vehicle scheduling device 30 can transmit the dynamic information to the processor 34.

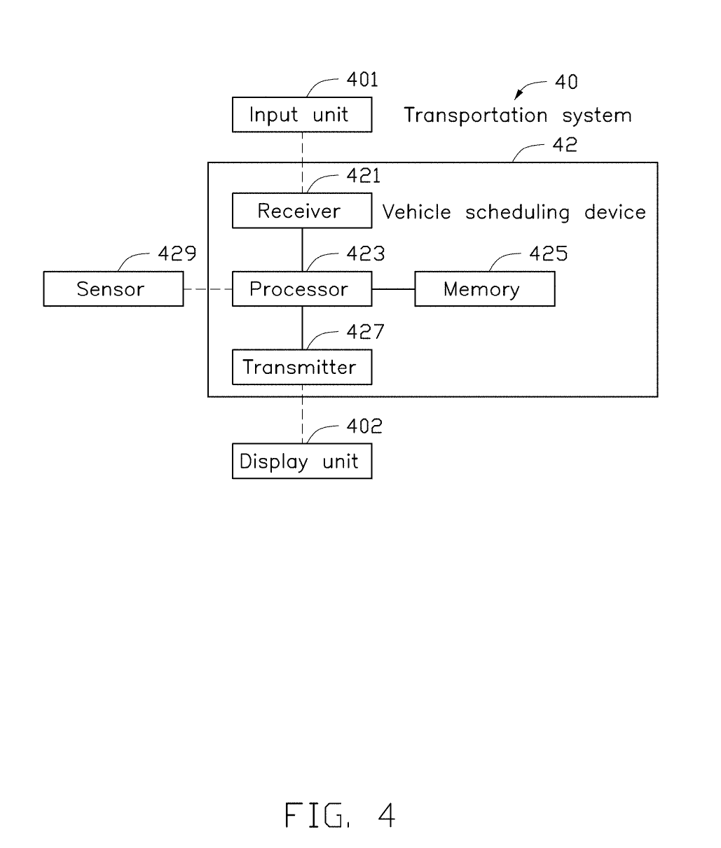

FIG. 4 illustrates one embodiment, a transportation system 40 comprises an input unit 401, a display unit 402 and a vehicle scheduling device 42, wherein the vehicle scheduling device 42 generally comprises a receiver 421, a memory 425, a processor 423, and a transmitter 427. The input unit 401 (e.g., cellular telephone, personal digital assistant (PDA), laptop, etc.) is configured to be operable by a user to input a scheduling plan. The scheduling plan comprises door environment parameters, operational parameters, and dynamic information (number of inbound vehicles, number of outbound vehicles, time of inbound arrival, time of outbound departure, types of shipment, capacity of shipment, number of inbound doors or number of outbound doors). The receiver 421 is configured to receive the scheduling plan. The memory 425 (or the processor 423) is coupled to the receiver 421 and configured to store the scheduling plan from the receiver 421. The processor 423 is coupled to the memory 421 and is configured to optimize the scheduling plan. The transmitter 427 is coupled to the processor 423 and is configured to transmit the optimal scheduling plan to the display unit 402. The display unit 402 (e.g., cellular telephone, personal digital assistant (PDA), laptop, etc.) is configured to display the optimal scheduling plan to the users. In some embodiments, the input unit 401 is coupled to the display unit 402. The input unit 401 and the display unit 402 are operated from the same device (e.g., cellular telephone, personal digital assistant (PDA), laptop, desktop etc.).

In at least one embodiment, the vehicle scheduling device 42 is coupled to a sensor 429 which can detect the situation of the transportation environment and transmit dynamic information automatically to the processor 423 without the dynamic information being input by users manually. For example, when the inbound vehicles begin the travel to the distribution center, the vehicle scheduling device 42 would automatically detect the time and the position of the inbound vehicles by the sensor 429 so that the vehicle scheduling device 42 can transmit the dynamic information to the processor 423.

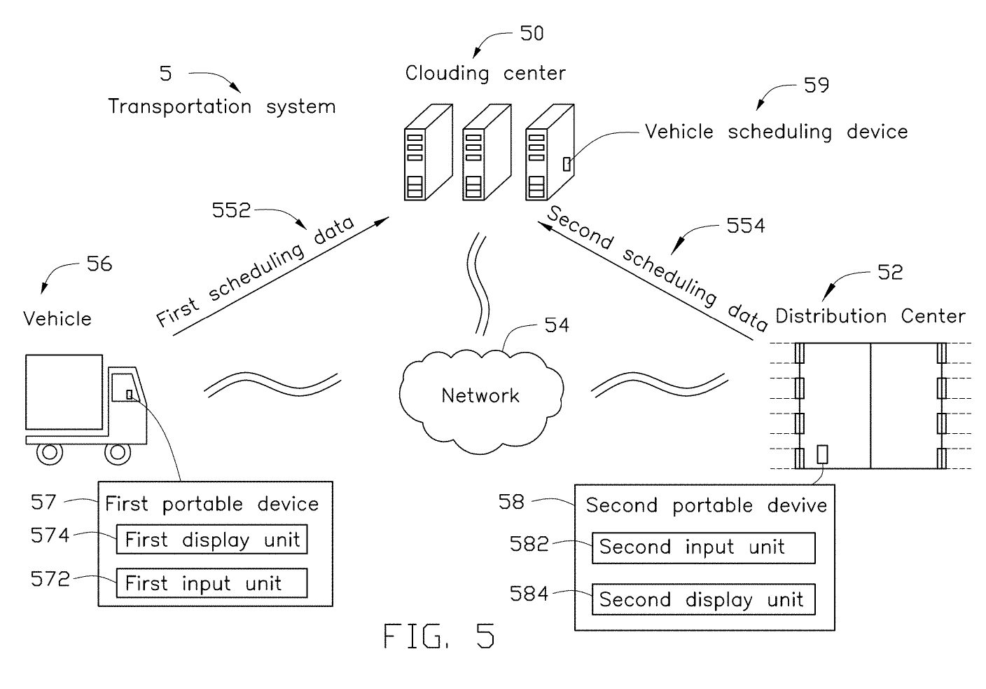

FIG. 5 illustrates an illustrative diagram showing the operation of a transportation system 5 in accordance with an implementation. In the illustrated embodiment, a vehicle driver in a vehicle 56 operates a first portable device 57 and inputs a first scheduling data 552 (for example, dynamic data or objective functions) of vehicle scheduling plan through an input unit 572 of the first portable device 57. The first scheduling data 552 is transmitted from the first portable device 57 to a vehicle scheduling device 59 in a cloud center 50. A user operates a second portable device 58 in a vehicle and inputs a second scheduling data 554 (for example, dynamic data or objective functions) of vehicle scheduling plan through a second input unit 582 (of the second portable device 58). The second scheduling data 554 is transmitted from the second portable device 58 to the vehicle scheduling device 59 in the cloud center 50. The vehicle scheduling device 59 is configured to process the first scheduling data 552 and the second scheduling data 554 through a program or an application so that the vehicle scheduling device 59 may accordingly generate an optimal scheduling plan. The driver in the vehicle 56 can receive the optimal scheduling plan via the first portable device 57 and see the optimal scheduling plan presented on an onboard first display unit 574. The user in the distribution center 52 can receive the optimal scheduling plan via the second portable device 58 and see the optimal scheduling plan on a second display unit 584 (of the second portable device 58). In this embodiment, the first portable device 57, the second portable device 58, and the vehicle scheduling device 59 are coupled together through a network 54.

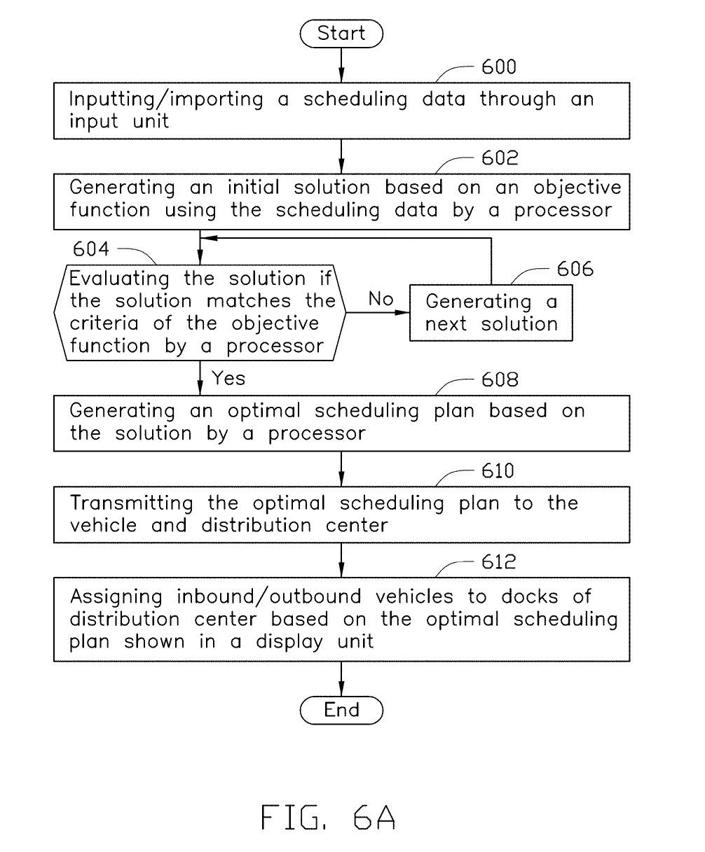

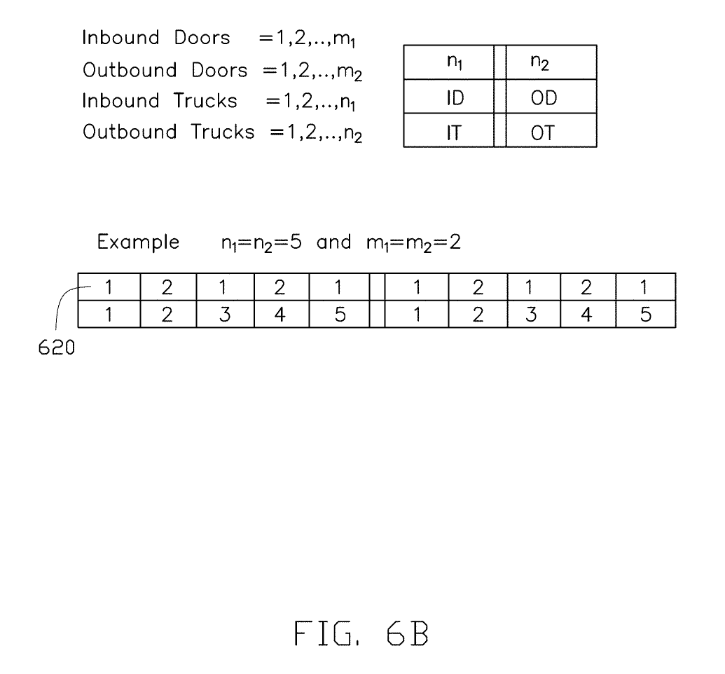

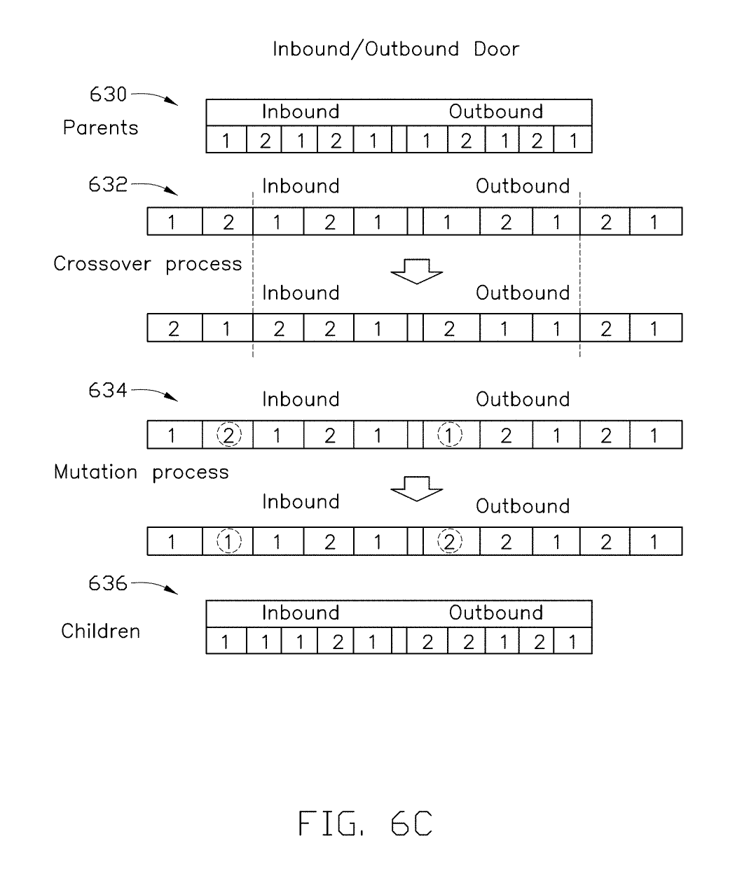

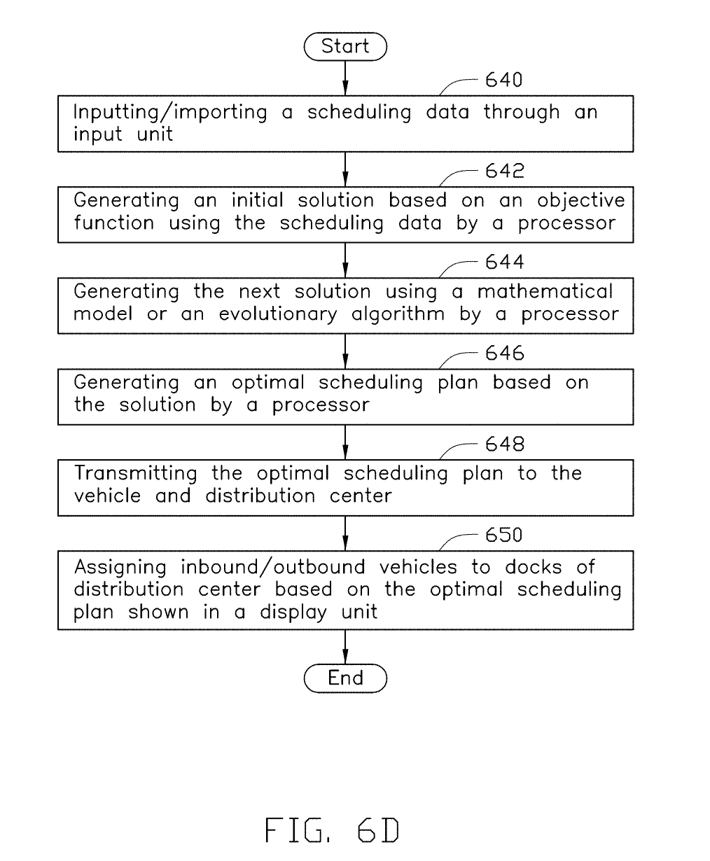

FIG. 6A is a flowchart of an example vehicle scheduling process. The example process of FIG. 6A can be implemented by the transportation systems described in FIGS. 1-5.

In block 600, scheduling data is input or imported by users. In some embodiments, the scheduling data can be input or imported through any device in the transportation system. For example, some vehicles have a sensing device to detect the transportation environment (such as estimated travel time, capacity of shipment, etc.) when the vehicles begin to move to a distribution center.

In block 602, an initial solution can be generated based on the objective function using the scheduling data. More specifically, the initial solution is encoded based on the scheduling data when the objective function is provided. For example, if the objective function is selected to be “Minimum travel time” to minimize the total travel time of forklifts on the dock, the initial solution would be generated in accordance with the scheduling data, which may include the door environment parameters, the operation parameters, and/or the dynamic information.

In block 604, the solution is evaluated if it matches the criteria of the objective function. When the solution matches the criteria of the objective function, the solution will be considered as optimal solution of the process. When the solution does not match the criteria of the objective function, the block 604 will go to block 606 to generate a next solution. The next solution will be evaluated again in the block 604 until one of the solutions matches the criteria of the objective function. In some embodiments, the solution in the block 604 and the block 606 may be generated through mathematical model or algorithm in order to get an optimal result, such as Genetic algorithm (GA), Simulated Annealing (SA), CHC Method (CHC), Evolution Strategy (ES), Ant Colony Optimization (ACO), GA+SA Hybrid Algorithm, Cooperative Local Search (CLS) or Particle Swarm Optimization (PSO). In some embodiment, the next solution can be generated through the block 606 without the process of criteria matching in block 604 as shown in FIG. 6D.

In block 608, an optimal scheduling plan is generated based on the solution which passes the evaluation in the block 604. In some embodiments, the optimal scheduling plan may be generated in the cloud center.

In block 610, the optimal scheduling plan is transmitted to the vehicle and the distribution center.

In block 612, inbound/outbound vehicles are assigned to dock doors of a distribution center based on the optimal scheduling plan shown in a display unit. For example, an inbound vehicle driver can receive the optimal scheduling plan to change loading docks in the distribution center. In other words, the staff in the distribution center can receive the optimal scheduling plan to prepare for unloading at the assigned dock and also understand what type of shipment should be unloaded in the assigned dock.

Take GA as an example, GA is a powerful and robust heuristic approach for large-scale combination optimization problems. In GA, each solution of the problem is represented using some coding scheme and the resulting representation is called a chromosome which is encoded from a scheduling plan. For example, referring to FIG. 6B, for n vehicles, the solution's length is n. The first n₁ pairs correspond to the inbound doors (ID) and inbound trucks (IT). The next n₂ pairs correspond to the outbound doors (OD) and outbound trucks (OT). When a transportation system has two inbound doors (m₁=2), two outbound doors (m₂=2), five inbound vehicles (n₁=5) and five outbound vehicles (n₂=5) at a distribution center, the solution can be encoded as a chromosome as shown in the figure. Population is a set of chromosomes. Each chromosome can be translated into a solution for the vehicle scheduling. In other words, The chromosomes can be encoded and shown as a set of chromosomes 620 called population.

GA is an iterative search method that is initiated with a population of solutions (represented as chromosomes). Typically the starting population is generated by random arrangement of chromosomes. At iteration, the population is changed by two types of operations. The first operation randomly selects two solutions from the population as parents and then replaces them with two children generated from them by a re-combination operation called crossover. The second operation randomly selects a solution from the population and then either changes the selected solution slightly (mutation), or replaces it with another solution from outside (immigration). Solutions from one population are taken and used to form a new population.

FIG. 6C illustrates one embodiment as the method started by generating an optimal solution at door assignments according to GA. The fitness value (objective function value, i.e. consolidation time) of each chromosome is evaluated. After that, chromosomes (at least one solution of door assignments) are selected as parents 630 to go through the crossover process 632 and mutation process 634 and generate children 636 (another solution of door assignments). If a child of the children 636 is better than one of the parents 630, then the parent 630 is replaced by the child and put back to the population. The process is repeated until termination criteria are satisfied. The criteria are maximum number of iterations and allowable consecutive number of iterations without improvement to the best solution in the population (optimal solution of door assignments).

In at least one embodiment referring to flowchart according to FIG. 6A, the vehicle scheduling method will be repeated if the scheduling data is updated by the users. For example, when one of the vehicles has an accident, the scheduling data may be changed in order to make different assignments for all the vehicles. The users need to input updated dynamic information so that a new optimal scheduling plan can be generated and transmitted to other vehicles and the distribution center.

FIG. 6D is a flowchart of another example vehicle scheduling process. The example process of FIG. 6D can be implemented by the transportation systems described in FIGS. 1-5.

In block 640, scheduling data is input or imported by users. In some embodiments, the scheduling data can be input or imported through any device in the transportation system. For example, some vehicles have a sensing device to detect the transportation environment (such as estimated travel time, capacity of shipment, etc.) when the vehicles begin to move to a distribution center.

In block 642, an initial solution can be generated based on the objective function using the scheduling data. More specifically, the initial solution is encoded based on the scheduling data when the objective function is provided. For example, if the objective function is selected to be “Minimum travel time” to minimize the total travel time of forklifts on the dock, the initial solution would be generated in accordance with the scheduling data, which may include the door environment parameters, the operation parameters, and/or the dynamic information.

In block 644, the next solution can be generated by using a mathematical model or an evolutionary algorithm by a processor until the optimal or near optimal solution is met. In some embodiments, the mathematical model or algorithm can be Genetic algorithm (GA), Simulated Annealing (SA), CHC Method (CHC), Evolution Strategy (ES), Ant Colony Optimization (ACO), GA+SA Hybrid Algorithm, Cooperative Local Search (CLS) or Particle Swarm Optimization (PSO).

In block 646, an optimal scheduling plan is generated based on the solution. In some embodiments, the optimal scheduling plan may be generated in the cloud center.

In block 648, the optimal scheduling plan is transmitted to the vehicle and the distribution center.

In block 650, inbound/outbound vehicles are assigned to dock doors of a distribution center based on the optimal scheduling plan shown in a display unit. For example, an inbound vehicle driver can receive the optimal scheduling plan to change loading docks in the distribution center. In other words, the staff in the distribution center can receive the optimal scheduling plan to prepare for unloading at the assigned dock and also understand what type of shipment should be unloaded in the assigned dock.

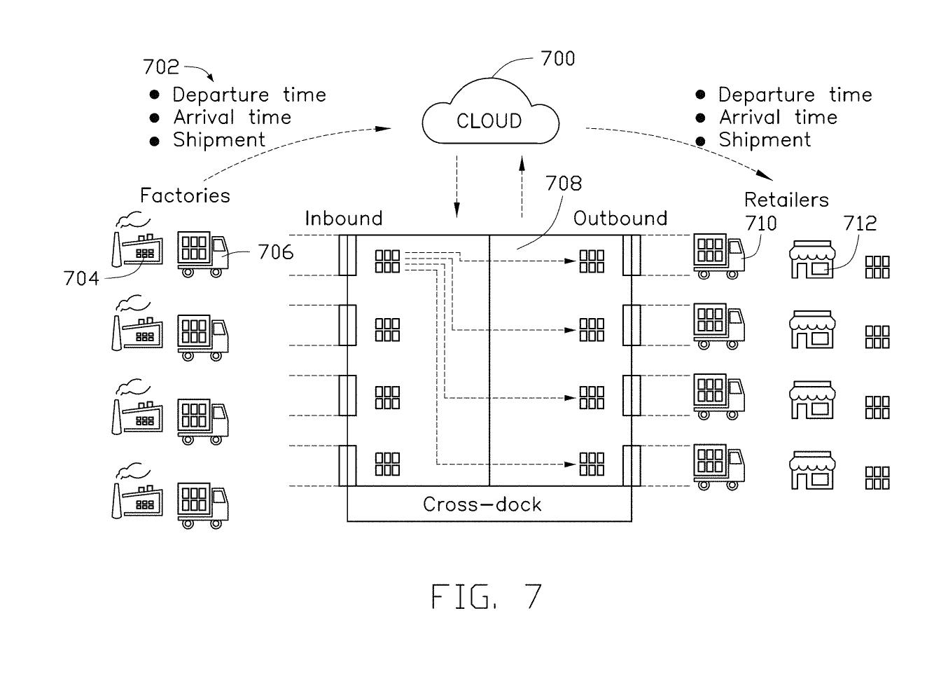

FIG. 7 illustrates an embodiment of an operation of a transportation system based on the vehicle scheduling method. Inbound vehicles 706 can carry different types of shipments from different factories 704 to a distribution center 708. The inbound vehicles can transmit the information (e.g., transmitting information of departure time, arrival time or types of shipment) to a cloud 700 on the way to the distribution center 708. Likewise, outbound vehicles 710 can carry different types of products from the distribution center 708 to the retailers 712. The outbound vehicles can transmit the information (e.g., transmitting information about departure time, arrival time or types of shipment) to the cloud 700 on the way to the retailers 712. The cloud 700 is configured to handle the information from inbound vehicles and the outbound vehicles. The vehicle scheduling process mentioned in the flowchart in FIG. 6A and FIG. 6D can be implemented in the cloud 700 based on the information 702 so that the inbound vehicles, outbound vehicles and distribution center can receive an optimal scheduling plan at the same time adjust the previous scheduling plan. The inbound vehicles can follow the optimal scheduling plan to choose which inbound dock door for unloading the shipment. The staff in the distribution center knows the assignment of the shipment and moves the shipment to the right outbound dock based on the vehicle scheduling plan. The outbound vehicles can stay at the assigned dock and upload the shipment.

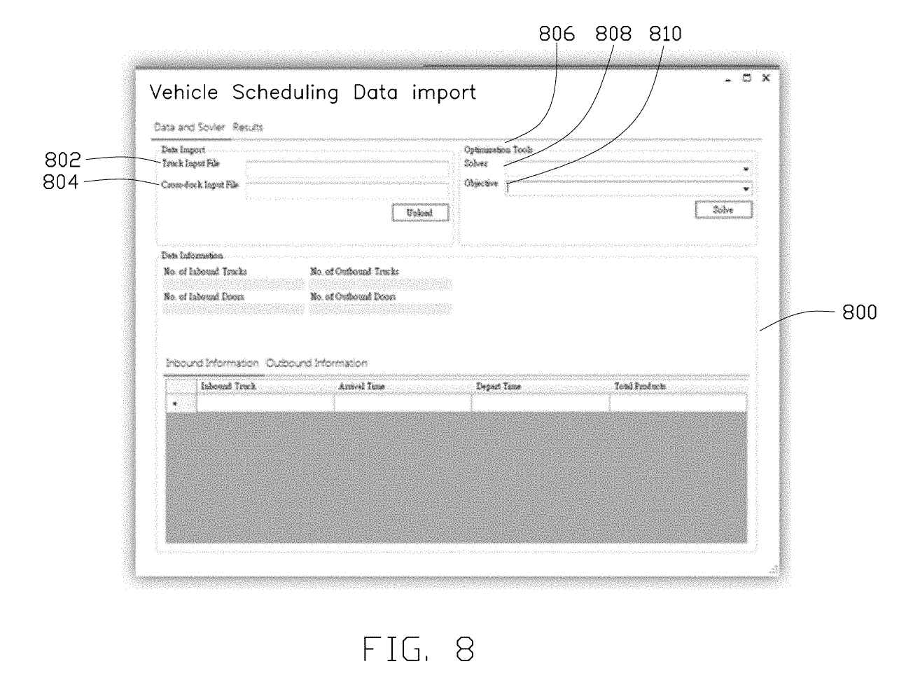

FIG. 8 illustrates an embodiment of an application interface 800 for a vehicle scheduling device is provided. Users can use the application interface 800 to import/upload vehicle scheduling data including dynamic information, such as vehicle input file 802 or cross-dock input file 804. The users can also choose optimization tool 806 including solution 808 (ex: Genetic algorithm (GA) or first come first serve) and objective 810 (ex: “travel time minimum”, “makespan minimum”, “total late time minimum” and “late minimum of outbound vehicles”).

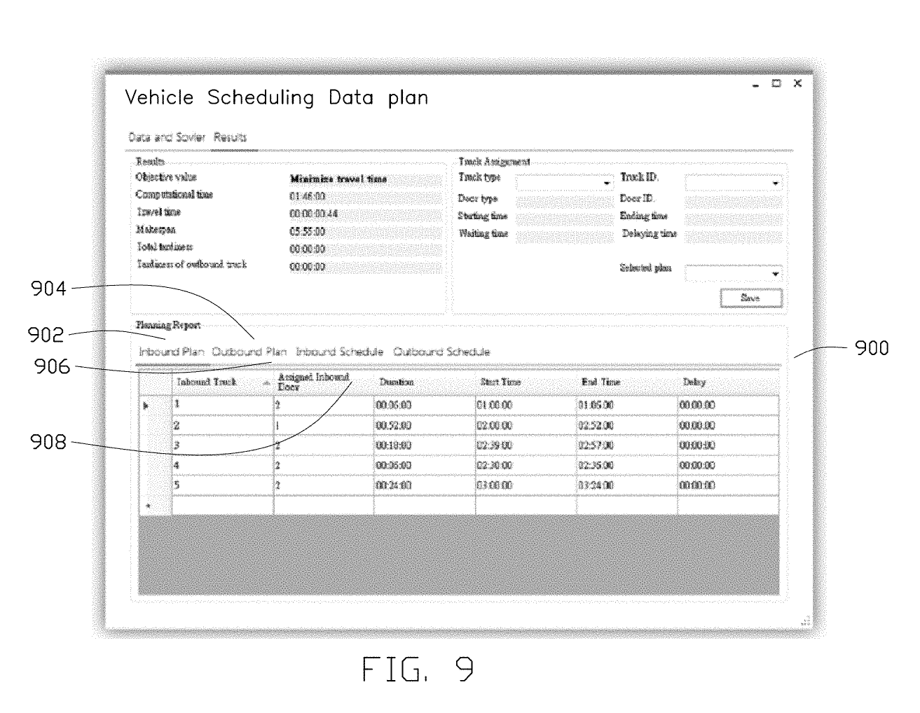

FIG. 9 illustrates another embodiment of an application interface 900 for a vehicle scheduling device is provided. The application interface 900 shows optimal scheduling plan after a vehicle scheduling method is implemented in the vehicle scheduling device. For example, the optimal scheduling plan comprises inbound plan 902 and outbound plan 904. The inbound plan 902 shows assignments for inbound vehicles, wherein the inbound vehicle 906 is assigned to the assigned door 908.

The embodiments shown and described above are only examples. Many details are often found in the art such as the other features of a vehicle scheduling device and method for transportation system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vehicle scheduling device comprising:
a processor configured to perform at least one objective function;
an input interface communicatively coupled to the processor and configured to accept input of a scheduling data, wherein the scheduling data comprises at least one of a door environment parameter, an operational parameter, and a dynamic information;
a computer readable medium coupled to the processor and configured to receive the scheduling data, the computer readable medium further comprising instructions stored therein which, upon execution by the processor, causes the processor to perform operations comprising:
generating an initial solution based on the objective function with a criteria and the scheduling data,
generating a next solution;
generating an optimal scheduling plan based on a solution matching the criteria; and
a display device coupled to the processor and configured to output a visual representation of the optimal scheduling plan.

2. The vehicle scheduling device of claim 1, wherein the solution is provided by:
evaluating whether the initial solution matches a criteria of the objective function; and generating the next solution if the initial solution fails to match the criteria.

3. The vehicle scheduling device of claim 1, wherein the processor is further configured to, upon execution of the instructions, assign vehicles to docks of a distribution center based on the optimal scheduling plan.

4. The vehicle scheduling device of claim 1, the door environment parameters and operational parameters are pre-stored in the memory.

5. The vehicle scheduling device of claim 1, wherein the dynamic information further comprises the departure time of the vehicle, arrival time of the vehicle, shipment capacity of the vehicle, the types of shipment, the number of doors, or the types of product in the shipment.

6. The vehicle scheduling device of claim 1, wherein the door environment parameters comprises service modes and number of dock doors.

7. The vehicle scheduling device of claim 6, wherein the service modes comprises an exclusive mode which the dock doors either for inbound or outbound operations are separated, a mixed mode which the dock door is not exclusively for the purpose of an inbound or outbound door only, an exclusive-mixed mode which is parallel usage of both exclusive and mixed modes, and a given mode which the door assignment of each vehicle is given by a certain destination.

8. The vehicle scheduling device of claim 1, wherein the operational parameter is related to parameters comprise at least one of pre-emption existence, arrival time, processing time, due dates, intermediate storage parameter, assignment restriction, transshipment time, outbound organization, type of shipment, and interchangeable product.

9. The vehicle scheduling device of claim 1, wherein the objective function comprises at least one of a “travel time minimum”, a “makespan minimum”, a “total late time minimum”, and a “late minimum of outbound vehicles”.

10. The vehicle scheduling device of claim 1, wherein the initial solution is defined based on the scheduling data when the objective function is provided.

11. The vehicle scheduling device of claim 1, wherein the processor is further configured to, upon execution of the instruction stored in the computer readable medium, iterate at least one of the operation if the scheduling data is updated so that the optimal scheduling plan refreshable.

12. The vehicle scheduling device of claim 1, wherein the vehicle scheduling device further comprises a sensor capable of detecting a transportation environment and transmit the dynamic information to the processor automatically.

13. A transportation system comprising:
an input unit configured to accept input of a scheduling data, wherein the scheduling data comprises at least one of a door environment parameters, an operational parameters, and a dynamic information;
a vehicle scheduling device comprising:
a processor configured to perform at least one objective function;
a receiver coupled to the processor configured to receive the scheduling data from the input unit;
a computer readable medium coupled to the processor and configured to receive the scheduling data, the computer readable medium further comprising instructions stored therein which, upon execution by the process, causes the processor to perform operations comprising:
generating an initial solution based on the objective function and the scheduling data,
evaluating whether the initial solution matches a criteria of the objective function, and generating a next solution if the initial solution fails to match the criteria, and
generating an optimal scheduling plan based on a solution matching the criteria; and
a transmitter coupled to the processor and configured to transmit the optimal scheduling plan; and
a display unit configured to receive the optimal scheduling plan from the vehicle scheduling device and output a visual representation thereof.

14. The transportation system of claim 13, wherein the processor is further configured to, upon execution of the instructions stored in the computer readable medium, assign vehicles to docks of a distribution center based on the optimal scheduling plan.

15. The transportation system of claim 13, wherein the vehicle scheduling device is coupled a sensor capable of detecting a transportation environment and transmit the dynamic information to the vehicle scheduling device automatically.

16. A vehicle scheduling method performed by the transportation system, comprising the steps of:
importing a scheduling data through an input unit;
generating an initial solution based on an objective function using the scheduling data by a processor;
generating a next solution by the processor;
generating an optimal scheduling plan based on the solution by the processor; and
displaying the optimal scheduling plan on the display screen by a display unit.

17. The vehicle scheduling method of claim 16, further comprising iterating at least one of the steps if the scheduling data is updated so that the optimal scheduling plan refreshable.

18. The vehicle scheduling method of claim 17, wherein the solution is generated based on a Genetic algorithm (GA).

19. The vehicle scheduling method of claim 18, wherein the stopping criteria of the Genetic algorithm (GA) are maximum number of iterations and allowable consecutive number of iterations without improvement to the best solution.
